(19) United States
(12) Patent Application Publication
(10) Pub. No.: US 2014/0118554 A1
(43) Pub. Date: May 1, 2014

(54) System of a Surveillance Camera For Identifying And Incapacitating Dangerous Intruders

(71) Applicant: Valentine A. Bucknor, Hartford, CT (US)

(72) Inventor: Valentine A. Bucknor, Hartford, CT (US)

(21) Appl. No.: 13/663,752

(22) Filed: Oct. 30, 2012

(51) Int. Cl. H04N 7/18

(52) U.S. Cl. 348/155; 348/E07.085

(57) ABSTRACT

A system of a surveillance camera for identifying and incapacitating dangerous intruders is a standard video camera with an additional infrared camera and an electrical stun gun. A data processing module in the camera utilizes body detection and tracking software to scan images received from the camera for human bodies, and a threat detection sensor communicates with the data processing module in order to identify a specific human body in the images as a threat. Once a threat is identified, the camera continually repositions itself so that at any given moment, a remote control can trigger the deployment of the electrical stun gun to incapacitate the threat. The data processing module also scans the facial and retina characteristics of the threat and stores the information in an information storage module at the back of the camera.

### FIELD OF THE INVENTION

The present invention relates generally to security systems. More particularly, the present invention relates to a surveillance camera system that identifies and incapacitates dangerous intruders.

### BACKGROUND OF THE INVENTION

In any place of business, especially one that sells items of high value or that process a significant amount of cash transactions, there is a risk of individuals attempting to acquire items without paying. The majority of stores employ loss prevention techniques, including surveillance by video cameras, radio frequency or electromagnet anti-shoplifting devices, and security personnel. In addition to having their goods stolen, a further risk to a business is being robbed by demanding the cashier empty the cash register and threatening the cashier with physical violence if the cashier does not comply. To mitigate such a situation, business owners often keep a firearm behind the counter to allow the cashier or business owner to attempts to fend off the intruder. However, there is often little time to pick up and ready the weapon, as the intruder is already in a heightened state of awareness and preparation, while the person working the counter must process the fact that there is a dangerous intruder and must drastically and quickly change their state of mind in order to react appropriately, and is likely to be unable to reach the weapon due to raising their hands in surrender.

It is therefore an object of the present invention to provide a surveillance camera system that autonomously indentifies a dangerous intruder and prepares an incapacitating electric stun gun to be fired at the intruder at the push of a button.

### BRIEF DESCRIPTION OF THE DRAWINGS

FIG. 1 is a front perspective view of the present invention attached to a section of ceiling.

FIG. 2 is a side view of the present invention attached to a section of ceiling.

FIG. 3 is a top view of the present invention.

FIG. 4 is a diagram illustrating the use of the present invention, as well as wireless communication between the data processing module and the threat detection sensor and the remote.

FIG. 5 is a block diagram illustrating the electronic connections of the present invention.

FIG. 6 is a stepwise flow diagram describing the method of operating the present invention.

FIG. 7 is a stepwise flow diagram describing additional steps of the method of operating the present invention for identifying human bodies from surveillance images.

FIG. 8 is a stepwise flow diagram describing additional steps of the method of operating the present invention for tracking a threat with the electrical stun gun.

FIG. 9 is a stepwise flow diagram describing additional steps of the method of operating the present invention for identifying a threat.

### DETAIL DESCRIPTIONS OF THE INVENTION

All illustrations of the drawings are for the purpose of describing selected versions of the present invention and are not intended to limit the scope of the present invention.

The present invention generally comprises a camera 1, an infrared camera 2, an electrical stun gun 3, a threat detection sensor 4, a remote control 5, a threat information storage module 6, a laser rangefinder 7, and a data processing module 8.

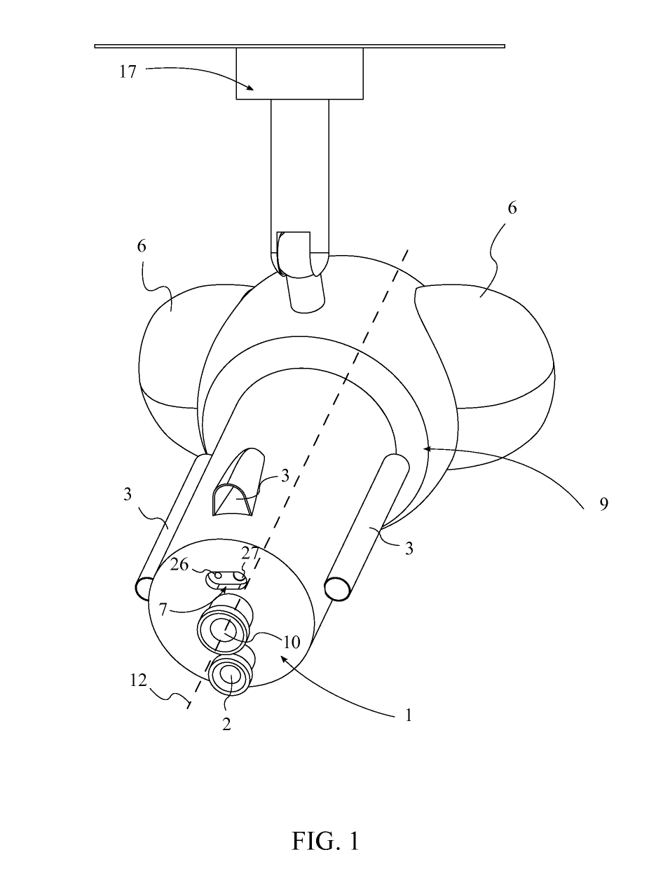

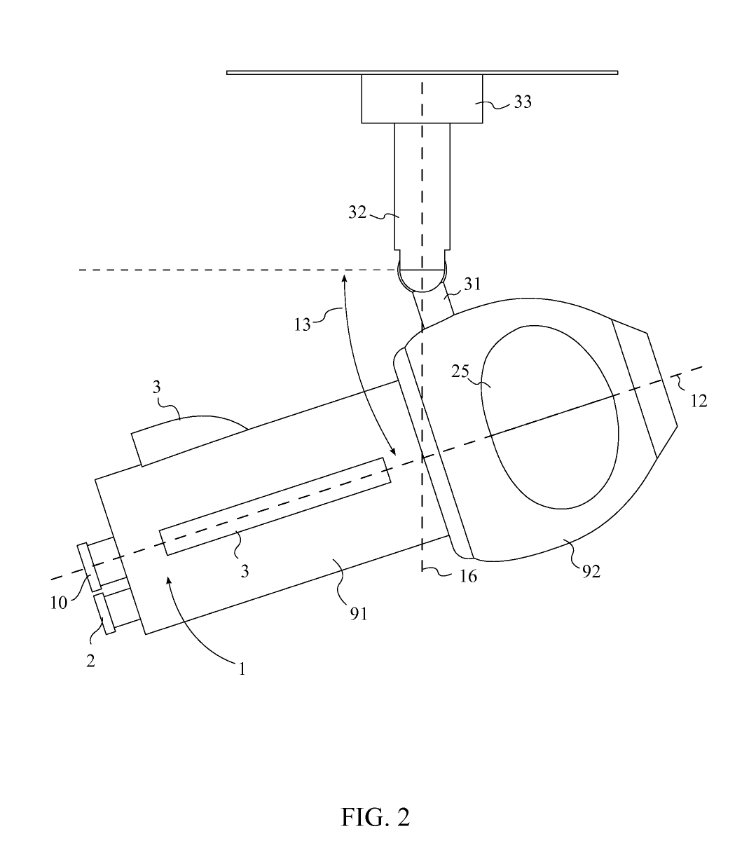

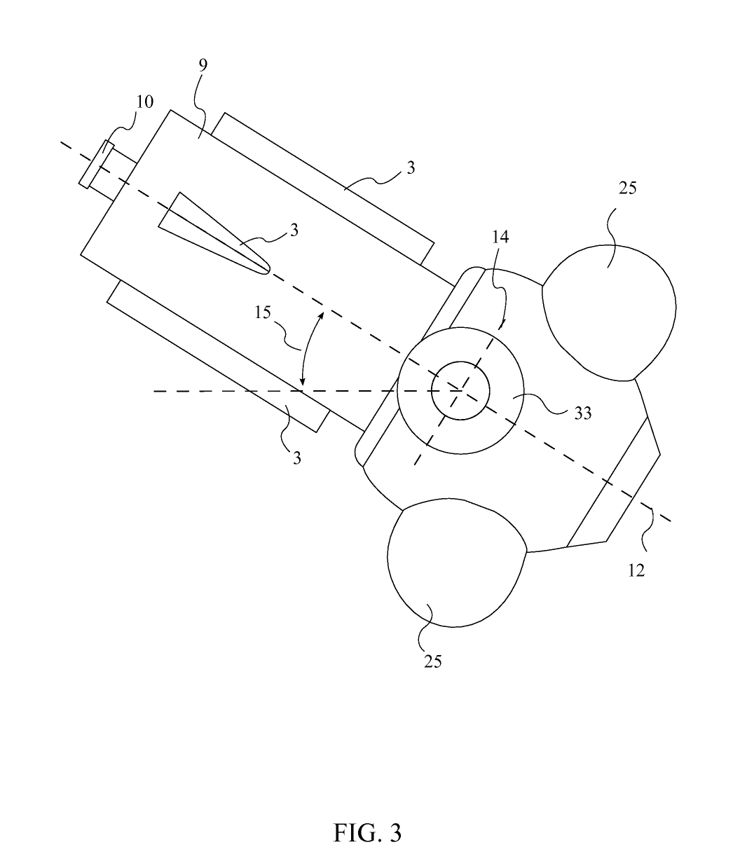

Referring to FIGS. 1-3, the camera 1 utilizes well-known technology to capture and record video and still images and to adjust the angle of orientation of the camera 1 in order to facilitate the broadest area of surveillance possible. The camera 1 comprises a housing 9, a lens 10, an image capturing chip 11, a central axis 12, an inclination angle 13, an inclination axis 14, an azimuth angle 15, an azimuth axis 16, a mount 17, an inclination motor 18, an azimuth motor 19, and a camera wireless radio communication device 20.

The housing 9 is the outer casing of the camera 1 that supports and surrounds the main components of the camera 1. The housing 9 is preferably made of a durable plastic or metal. In the preferred embodiment of the present invention, the housing 9 comprises a forward section 91 and a rear section 92. The forward section 91 is cylindrical and the rear section 92 has a globular bulb shape. The rear section 92 is concentrically connected to the forward section 91 along the central axis 12 opposite the lens 10. The lens 10 is a well-known optical component of cameras made of curved glass that converges incoming light onto the image capturing chip 11. The lens 10 is supported at the front of the forward section 91 in a manner typical of cameras. The image capturing chip 11 is also a well-known component of cameras that converts received optical images into an electronic signal. The image capturing chip 11 is preferably either a charge-coupled device (CCD) or a complementary metal-oxide-semiconductor (CMOS) circuit. The image capturing chip 11 is positioned within the housing 9.

The central axis 12 is an axis oriented in the direction the camera 1 is facing, passing through the center of the lens 10 and oriented normal to the lens 10.

The inclination angle 13 is the angle between a direction perpendicular to the force due to the earth's gravity, or a horizontal direction, and the central axis 12. In other words, the inclination angle 13 is the angle that changes by rotating around an axis perpendicular to the force due to the earth's gravity. The inclination axis 14 is the axis about which the camera 1 rotates in order to change the inclination angle 13.

The azimuth angle 15 is the angle formed between a reference direction perpendicular to the force due to the earth's gravity and a line along the central axis 12 to a point of interest projected onto the same horizontal plane as the reference direction. In other words, the azimuth angle 15 is the angle that changes by rotating around an axis parallel to the force due to the earth's gravity to allow the camera 1 to sweep side to side. The azimuth axis 16 is the axis about which the camera 1 rotates in order to change the azimuth angle 15. The azimuth axis 16 and the inclination axis 14 are perpendicular to each other, and the inclination axis 14 is perpendicular to the central axis 12.

The mount 17 is a structural element that is connected between the housing 9 and a wall, ceiling or other surface to enable the camera 1 to be positioned in a desired location for optimal surveillance. The mount 17 enables the camera 1 to rotate 180 degrees about the inclination axis 14 and 360 degrees about the azimuth axis 16 in order to obtain a desired orientation for surveillance and for deploying the electrical stun gun 3 against a threat. In the preferred embodiment of the invention, the mount 17 comprises an extension arm 31, a hinge arm 32 and a hinge support 33.

The extension arm 31 is a rod that is centrally positioned on the rear section 92 by one extremity of the extension arm 31 perpendicular to the central axis 12 and the inclination axis 14, and is rotatably connected about the inclination axis 14 to the hinge arm 32 at the other extremity of the extension arm 31.

The hinge arm 32 is a structural member of the mount 17 that is connected between the extension arm 31 and the hinge support 33. The hinge connection between the extension arm 31 and the hinge arm 32 may utilize a ball on the extension arm 31 that is positioned within a circular cavity within the hinge arm 32, with an arc section cut out of a wall surrounding the cavity that allows the extension arm 31 to rotate with one degree of freedom about the inclination axis 14. The hinge connection may also comprise a cylindrical hole through the extension arm 31 that is concentrically positioned around a pin in the hinge arm 32, allowing the housing 9 support to rotate with one degree of freedom about the inclination axis 14. In alternate embodiments of the present invention, other methods of allowing the inclination angle 13 of the camera 1 to change may be utilized.

The hinge support 33 is a structural member that is affixed to a wall or ceiling by screws, nuts and bolts, or other appropriate means. In the preferred embodiment of the present invention, the hinge support 33 and the hinge arm 32 are cylindrical, and the hinge arm 32 is concentrically connected within the hinge support 33 and allowed to rotate 360 degrees about the azimuth axis 16 within the hinge support 33. In alternate embodiments of the present invention, other methods of allowing the azimuth angle 15 of the camera 1 to change may be utilized. The azimuth axis, the inclination axis, and the central axis intersect at the hinge connection between the extension arm and the hinge arm.

The inclination motor 18 is a motorized mechanical device that utilizes previously known means, such as, but not limited to, linear actuators, angular actuators, gears, pistons, and pulleys, to change the inclination angle 13 of the camera 1. The inclination motor 18 is positioned within the mount 17 and is engaged between the extension arm 31 and the hinge arm 32. In an alternate embodiment of the present invention, the inclination motor 18 is positioned outside the mount 17.

The azimuth motor 19 is a motorized mechanical device that utilizes previously known means, such as, but not limited to, linear actuators, angular actuators, gears, pistons, and pulleys, to change the azimuth angle 15 of the camera 1. The azimuth motor 19 is positioned within the mount 17 and is engaged between the hinge arm 32 and the hinge support 33. In an alternate embodiment of the present invention, the azimuth motor 19 is positioned outside the mount 17.

The camera wireless radio communication device 20 is a well-known electronic device that enables data transmission over a computer network via radio waves, preferably utilizing the Institute of Electrical and Electronics Engineers' 802.11 standards. In the preferred embodiment of the present invention, the camera 1 also comprises a wired network connection such as an ethernet port. The camera 1 may transmit video data and receive targeting and firing information, among other data, via the camera wireless radio communication device 20 or an ethernet port. In the preferred embodiment of the present invention, the camera 1 also has any other common wired connections that are typically utilized by cameras or closed-circuit television (CCTV) technology. The camera wireless radio communication device 20 is positioned within the housing 9.

The infrared camera 2 is a well-known device that forms an image using infrared radiation in a manner similar to a common camera 1, but operating at much higher radiation wavelengths, as high as 14,000 nanometers, whereas visible light cameras operate in the 450-750 nanometer wavelength range. The infrared camera 2 may be a cooled or an uncooled infrared detector, as is suitable to the application of the present invention. The infrared camera 2 is positioned adjacent to the lens 10 on the housing 9. The infrared camera 2 produces a thermal image, providing more data that facilitates better recognition and tracking of human bodies.

The electrical stun gun 3 is a device that propels incapacitating means to neutralize threats. The electrical stun gun 3 preferably utilizes well known technology commonly used by police forces. In the preferred embodiment of the present invention, the electrical stun gun 3 utilizes gunpowder, pressurized gas or a spring mechanism to propel one or more projectiles 21 connected by wires to an electrical power source, completing an electrical circuit upon contact with a target to immobilize the target. In another embodiment of the present invention, the projectile 21 is similar in size and shape to a shotgun shell and contains an electrical power source within the projectile 21, eliminating the need for wires connected to a power source and enabling a longer range of effect of the projectile 21.

In alternate embodiments of the present invention, alternate incapacitating means may be utilized, including, but not limited to, electrically conducting fluid streams, rubber bullets, tranquilizer or anesthetizing darts, or a non-lethal liquid or gas that irritates the eyes, nose and/or throat of the target.

In the preferred embodiment of the present invention, the electrical stun gun 3 is positioned laterally on the housing 9, such that an initial trajectory 34 of the projectile 21 is parallel to the central axis 12. In another embodiment of the present invention, the electrical stun gun 3 is installed in a location separate from the camera 1.

In the preferred embodiment of the present invention, the threat detection sensor 4 is a well-known metal detector device positioned around the entryway of a store or other location at which the camera 1 is installed in order to detect when a person carrying a firearm enters the area. The threat detection sensor 4 comprises a sensor wireless radio communication device 22. The sensor wireless radio communication device 22 is a well-known electronic device that enables data transmission over a computer network via radio waves, preferably utilizing the Institute of Electrical and Electronics Engineers' 802.11 standards.

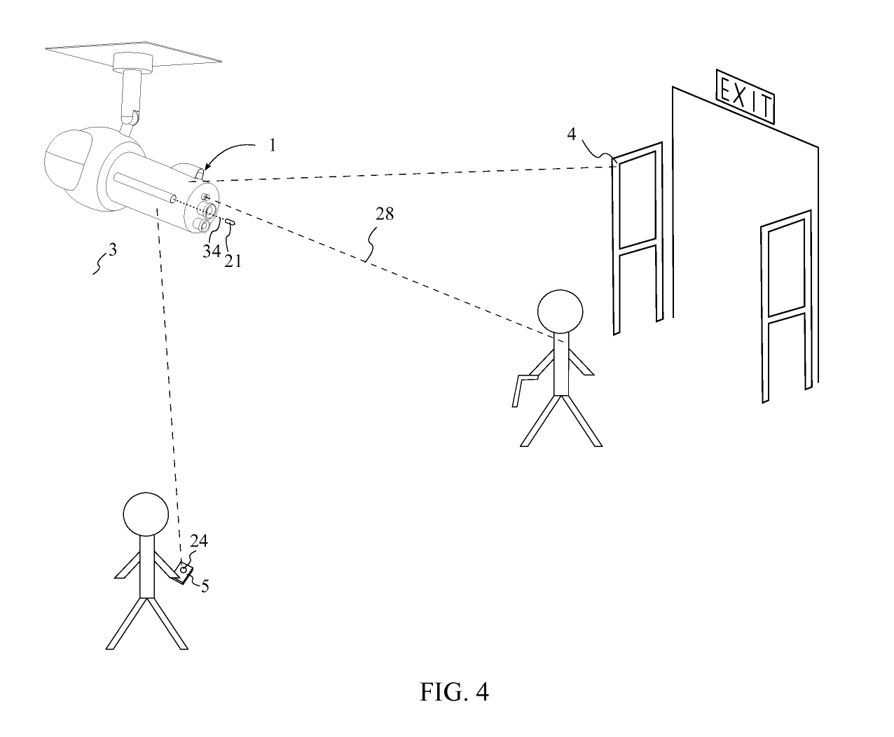

Referring to FIG. 4, the remote control 5 is a handheld device that allows a user to operate the present invention. The remote control 5 comprises a fire button 24 and a remote wireless radio communication device 23. The remote wireless radio communication device 23 is a well-known electronic device that enables data transmission over a computer network via radio waves, preferably utilizing the Institute of Electrical and Electronics Engineers' 802.11 standards. The remote wireless radio communication device is communicatively coupled with the camera wireless communication device. The fire button 24 is a push-button switch mechanism that triggers a signal through the remote wireless communication device to expel the projectile 21 towards a target. In the preferred embodiment of the present invention, a user may utilize their smartphone as a remote control 5, through an application utilizing a network connection to the camera wireless radio communication device 20. In the same spirit, other devices may be used as the remote control 20, including, but not limited to, a personal computer. A user that installs the present invention in their home is likely to utilize a personal computer to control the present invention. A further application of the present invention is to enable a user to pay a security firm or other entity to control the present invention through a remote monitoring system as part of a company's security measures. An additional feature is that upon detection of a threat, the local police department may be contacted in order for them to remotely take control of the present invention to neutralize the threat.

The threat information storage module 6 comprises two information drums 25 to store identification information retrieved from a threat. In the preferred embodiment of the present invention, the information drums 25 are digital data storage devices such as, but not limited to, flash memory, solid state hard drives, or a traditional spinning-disk hard drive, within which information captured from an intruder is stored, including, but not limited to, facial recognition information, retinal scan information, fingerprint information, or deoxyribonucleic acid (DNA) information. The two information drums 25 are positioned laterally opposite each other on the rear section 92.

The laser rangefinder 7 utilizes well-known technology to measure a distance to an object, surface or other target. The laser rangefinder 7 comprises a laser emitter 26 and a reflection detector 27. The laser emitter 26 sends a laser pulse in a narrow beam towards the target and the reflection detector 27 receives the reflected pulse. Distance to the target is determined by measuring the time taken for the pulse to be reflected off the target and return to the reflection detector 27. In the preferred embodiment of the present invention, the laser rangefinder 7 is positioned laterally on the housing 9 adjacent to the electrical stun gun 3 so that the direction of a distance vector 28 measure by the laser rangefinder 7 is parallel to the central axis 12, and so that the distance measured to a target by the laser rangefinder 7 is as close as possible to the distance from the electrical stun gun 3 to the target. The laser emitter 26 and the reflection detector 27 are positioned adjacent to each other within the laser rangefinder 7.

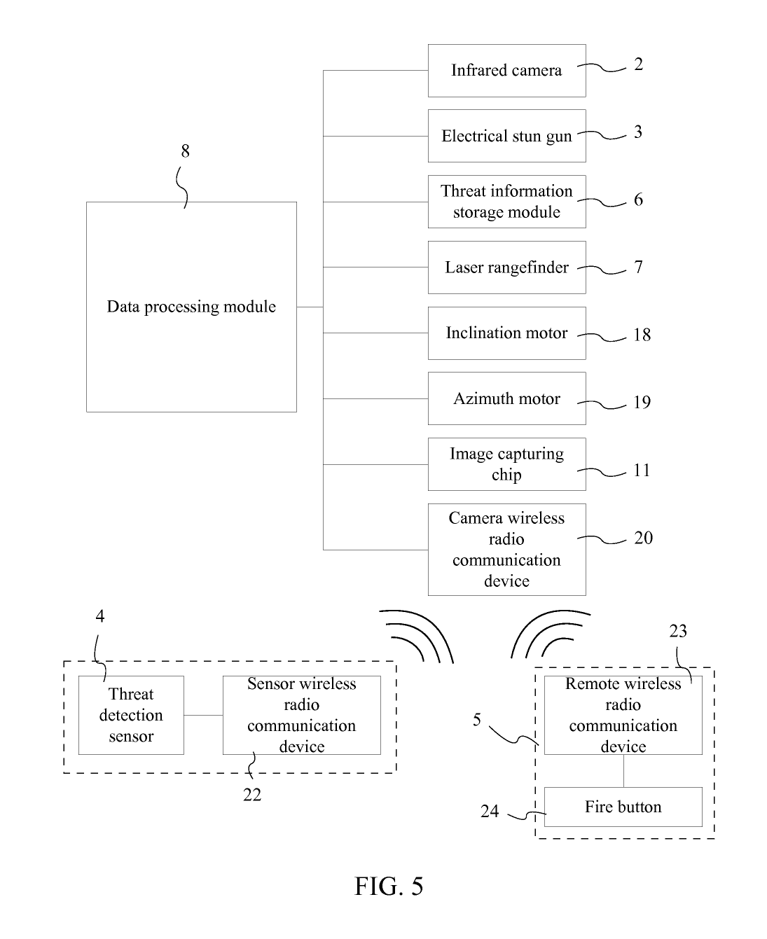

Referring to FIG. 5, the data processing module 8 is a component or combination of components of the electronic variety such as, but not limited to, circuit boards, wires, storage devices, and processors necessary to facilitate the translation of electrical input signals into desired effects and electrical output signals in the operation of the present invention. The data processing module 8 receives electrical input signals from various sources, such as, but not limited to, the image capturing chip 11, the infrared camera 2, the laser rangefinder 7 and the camera wireless radio communication device 20, processes the input, and sends electrical output signals to various appropriate components such as, but not limited to, the inclination motor 18, the azimuth motor 19, the camera wireless radio communication device 20, the electrical stun gun 3, and the threat information storage module 6. The data processing module 8 executes body tracking software and trajectory computing software. The data processing module 8 is preferably positioned within the housing 9. In an alternate embodiment of the present invention, the data processing module 8 is positioned in a location separate from the camera 1.

The data processing module 8 is electronically connected to the infrared camera 2, the electrical stun gun 3, the threat information storage module 6, the laser rangefinder 7, the inclination motor 18, the azimuth motor 19, the image capturing chip 11, and the camera wireless radio communication device 20.

The threat detection sensor 4 is communicatively coupled to the camera wireless radio communication device 20 through the sensor wireless radio communication device 22. The remote control 5 is communicatively coupled to the camera wireless radio communication device 20 through the remote wireless radio communication device 23.

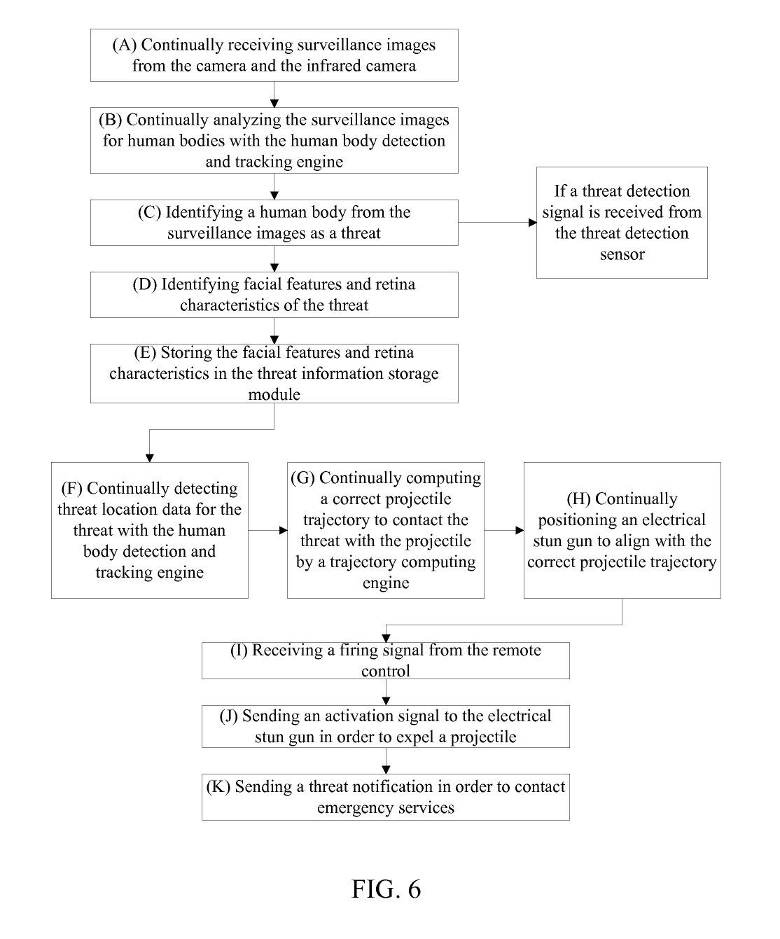

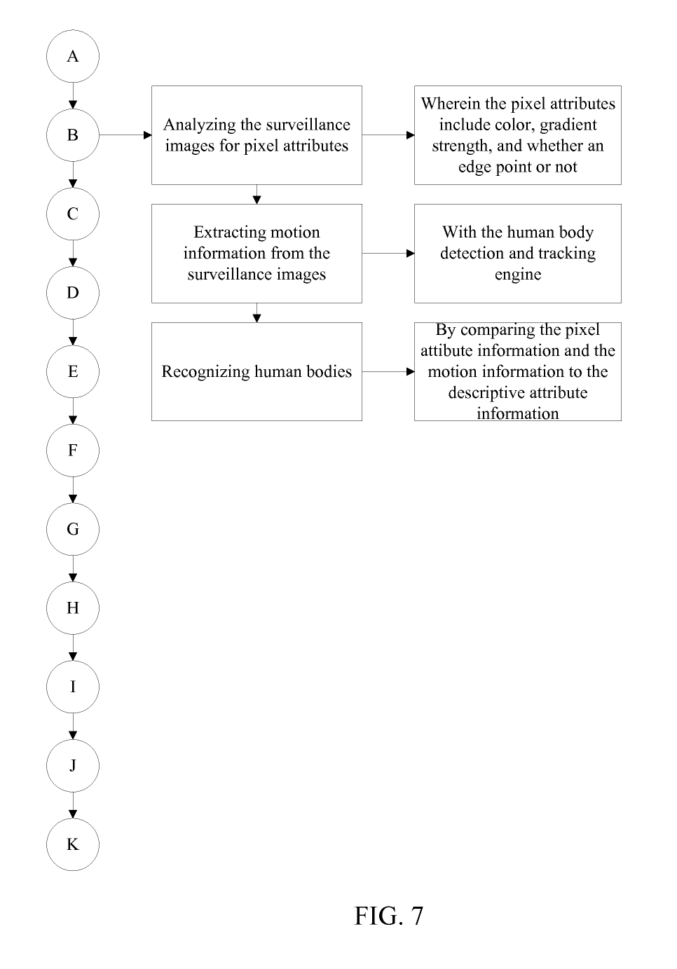

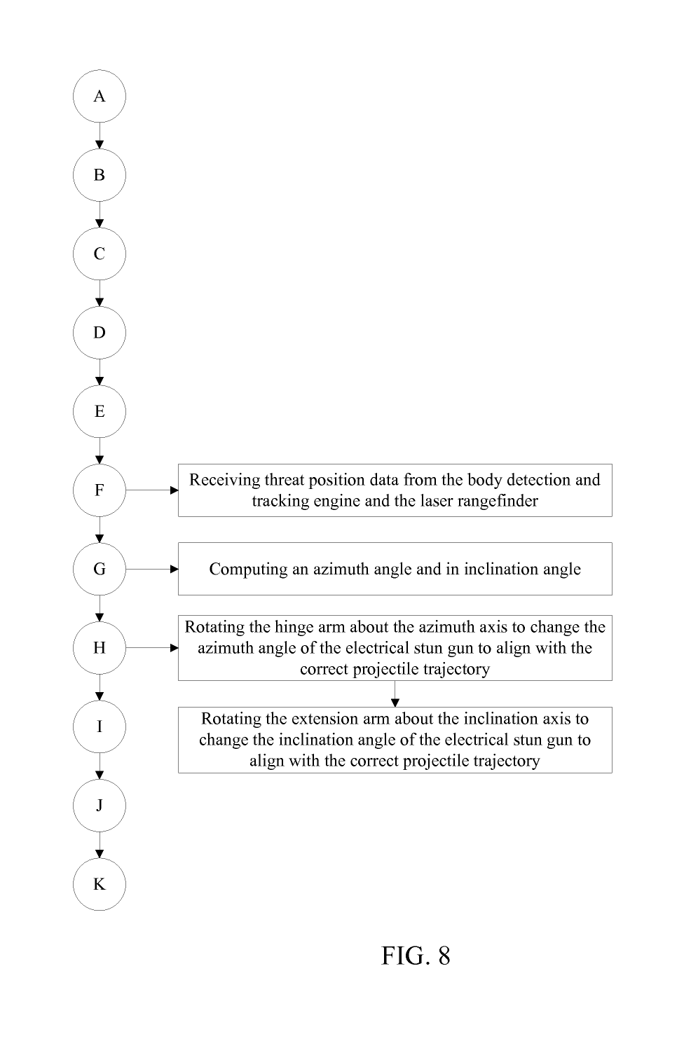

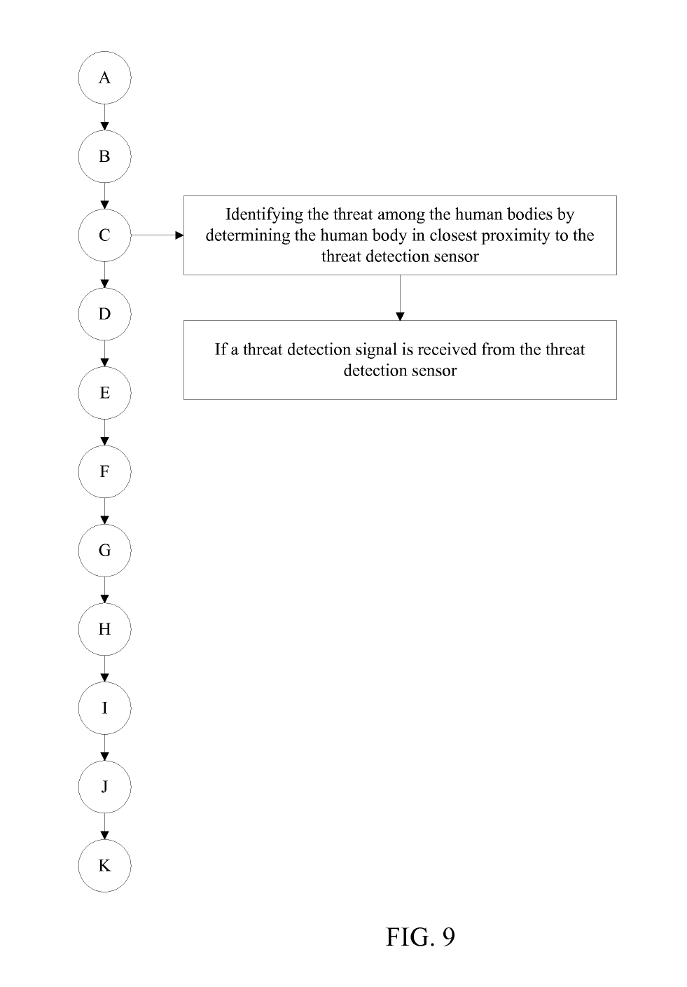

Referring to FIGS. 6-9, the method of operation of the present invention is as follows. A human body detection and tracking engine is provided, wherein the human body detection and tracking engine includes descriptive information and metrics for recognizing human body parts. A facial recognition engine and a trajectory computing engine are also provided. Surveillance images are continually received through the image capturing chip 11 and from the infrared camera 2. The surveillance images are analyzed by the data processing module 8 for human bodies with the human body detection and tracking software engine.

To detect human bodies, the surveillance images are analyzed for pixel attributes, such as, but not limited to, color, intensity, gradient strength, and whether a pixel or group of pixels is an edge or not, in addition to extracting motion information. Human bodies are recognized by comparing the pixel attributes and the motion information to the descriptive attribute information and metrics for recognizing human body parts.

Multiple human bodies may be detected and tracked at once. If a threat detection signal is received from the threat detection sensor 4, one of the human bodies detected is identified as a threat by determining the specific human body in closest proximity to the threat detection sensor 4. Once a threat is identified, facial features and retina characteristics of the threat are identified and stored in the threat information storage module.

The data processing module 8 utilizes the human body detection and tracking engine and distance data from the laser rangefinder 7 to determine and maintain a continually updated set of threat position data. A correct projectile trajectory to contact the threat with the projectile 21 is determined and continually updated to account for movement of the threat, where determining the correct projectile trajectory requires computing an azimuth angle 15 and an inclination angle 13, knowing the distance to the target and the initial velocity of the projectile 21. The extension arm 31 is rotated about the inclination axis 14 to change the azimuth angle 15 of the electrical stun gun 3 to align with the correct projectile 21 trajectory, and the hinge arm 32 is rotated about the azimuth axis 16 to align the inclination angle 13 of the electrical stun gun 3 with the correct projectile 21 trajectory. When the fire button 24 is pressed, a firing signal is sent to the camera 1 from the remote control 5. Upon receiving the firing signal, an activation signal is sent to the electrical stun gun to expel the projectile 21 toward the threat, and a threat notification is sent in order to contact emergency services.

Although the invention has been explained in relation to its preferred embodiment, it is to be understood that many other possible modifications and variations can be made without departing from the spirit and scope of the invention as hereinafter claimed.

What is claimed is,:

1. A system for a surveillance camera for identifying and incapacitating dangerous intruders comprises, a camera;
an infrared camera;
an electrical stun gun, wherein the electrical stun gun comprises a projectile;
a threat detection sensor;
a remote control;
a threat information storage module;
a laser rangefinder;
a data processing module, wherein the data processing module executes human body tracking software and trajectory computing software;
the camera comprises a housing, a lens, an image capturing chip, a central axis, a mount, an inclination motor, an azimuth motor, and a camera wireless radio communication device; and
the threat detection sensor comprises a sensor wireless radio communication device.

2. The system for a surveillance camera for identifying and incapacitating dangerous intruders as claimed in claim 1 comprises,
the housing being pivotably connected to the mount, wherein an azimuth angle of the housing is adjustable between zero and 360 degrees and an inclination angle of the housing is adjustable between zero and 180 degrees;
the azimuth axis and the inclination axis being perpendicular to each other;
the inclination axis being perpendicular to the central axis;
the mount comprises an extension arm, a hinge arm, and a hinge support;
the extension arm being connected to the housing;
the extension arm being rotatably connected to the hinge arm about an inclination axis;
the hinge support being rotatably connected to the hinge arm about an azimuth axis;
the inclination motor being engaged between the extension arm and the hinge arm;
the azimuth motor being engaged between the hinge arm and the hinge support; and
the image capturing chip, the data processing module, and the camera wireless radio communication device being positioned within the housing.

3. The system for a surveillance camera for identifying and incapacitating dangerous intruders as claimed in claim 2 comprises,
the housing comprises a forward section and a rear section;
the rear section being concentrically connected to the forward section along the central axis opposite the lens;
the extension arm being centrally positioned on the rear section perpendicular to the central axis and the inclination axis;
the threat information storage module comprises a plurality of information drums; and
the plurality of information drums being laterally positioned on the rear section.

4. The system for a surveillance camera for identifying and incapacitating dangerous intruders as claimed in claim 1 comprises,
the electrical stun gun being laterally positioned on the housing, wherein an initial trajectory of the stun gun projectile is parallel to the central axis;
the infrared camera being positioned on the housing adjacent to the lens;
the laser rangefinder being positioned on the housing adjacent to the lens, wherein the direction of a distance vector measured by the laser rangefinder is parallel to the central axis;
the laser rangefinder comprises a laser emitter and a reflection detector; and
the laser emitter and the reflection detector being positioned adjacent to each other within the laser rangefinder.

5. The system for a surveillance camera for identifying and incapacitating dangerous intruders as claimed in claim 1 comprises,
the remote control comprises a fire button;
the remote control comprises a remote wireless radio communication device; and
the remote wireless radio communication device being communicatively coupled with the camera wireless communication device.

6. The system for a surveillance camera for identifying and incapacitating dangerous intruders as claimed in claim 1 comprises,
the infrared camera, the electrical stun gun, the threat information storage module, the laser rangefinder, the inclination motor, the azimuth motor, the image capturing chip, and the camera wireless radio communication device being electronically connected to the data processing module; and
the threat detection sensor being communicatively coupled to the camera wireless radio communication device through the sensor wireless radio communication device;

7. A system for a surveillance camera for identifying and incapacitating dangerous intruders comprises,
a camera;
an infrared camera;
an electrical stun gun, wherein the electrical stun gun comprises a projectile;
a threat detection sensor;
a remote control;
a threat information storage module;
a laser rangefinder;
a data processing module, wherein the data processing module executes human body tracking software and trajectory computing software;
the camera comprises a housing, a lens, an image capturing chip, a central axis, a mount, an inclination motor, an azimuth motor, and a camera wireless radio communication device;
the housing being pivotably connected to the mount, wherein an azimuth angle of the housing is adjustable between zero and 360 degrees and an inclination angle of the housing is adjustable between zero and 180 degrees;
the threat detection sensor comprises a sensor wireless radio communication device;
the electrical stun gun being laterally positioned on the housing, wherein an initial trajectory of the stun gun projectile is parallel to the central axis;
the infrared camera being positioned on the housing adjacent to the lens;
the image capturing chip, the data processing module, and the camera wireless radio communication device being positioned within the housing. the housing comprises a forward section and a rear section;
the rear section being concentrically connected to the forward section along the central axis opposite the lens;
the extension arm being centrally positioned on the rear section perpendicular to the central axis and the inclination axis; and
the threat information storage module comprises a plurality of information drums; and
the plurality of information drums being laterally positioned on the rear section.

8. The system for a surveillance camera for identifying and incapacitating dangerous intruders as claimed in claim 7 comprises,
the azimuth axis and the inclination axis being perpendicular to each other;
the inclination axis being perpendicular to the central axis;
the mount comprises an extension arm, a hinge arm, and a hinge support;
the extension arm being connected to the housing;
the extension arm being rotatably connected to the hinge arm about an inclination axis;
the hinge support being rotatably connected to the hinge arm about an azimuth axis;
the inclination motor being engaged between the extension arm and the hinge arm; and
the azimuth motor being engaged between the hinge arm and the hinge support.

9. The system for a surveillance camera for identifying and incapacitating dangerous intruders as claimed in claim 7 comprises,
the laser rangefinder being positioned on the housing adjacent to the lens, wherein the direction of a distance vector measured by the laser rangefinder is parallel to the central axis;
the laser rangefinder comprises a laser emitter and a reflection detector; and
the laser emitter and the reflection detector being positioned adjacent to each other within the laser rangefinder.

10. The system for a surveillance camera for identifying and incapacitating dangerous intruders as claimed in claim 7 comprises,
the remote control comprises a fire button;
the remote control comprises a remote wireless radio communication device; and
the remote wireless radio communication device being communicatively coupled with the camera wireless communication device.

11. The system for a surveillance camera for identifying and incapacitating dangerous intruders as claimed in claim 7 comprises,
the infrared camera, the electrical stun gun, the threat information storage module, the laser rangefinder, the inclination motor, the azimuth motor, the image capturing chip, and the camera wireless radio communication device being electronically connected to the data processing module; and
the threat detection sensor being communicatively coupled to the camera wireless radio communication device through the sensor wireless radio communication device.

12. A method of operation of a surveillance camera for identifying and incapacitating dangerous intruders comprises,
providing an infrared camera, a threat detection sensor, a remote control, a laser rangefinder, a facial recognition and scanning engine, and a trajectory computing engine;
providing a camera, wherein the camera is connected to a multi-axis rotatable mount;
providing an electrical stun gun, wherein the electrical stun gun comprises a projectile;
providing a human body detection and tracking engine, wherein the human body detection and tracking engine includes descriptive attribute information for recognizing human body parts;
continually receiving surveillance images from the camera and the infrared camera;
continually analyzing the surveillance images for human bodies with the human body detection and tracking engine;
identifying a specific human body from the surveillance images as a threat,
if a threat detection signal is received from the threat detection sensor;
identifying facial features and retina characteristics of the threat;
storing the facial features and retina characteristics in the threat information storage module;
continually detecting threat location data for the threat with the human body detection and tracking engine and the laser rangefinder;
continually computing a correct projectile trajectory to contact the threat with the projectile by the trajectory computing engine;
continually positioning the electrical stun gun to align with the correct projectile trajectory;
receiving a firing signal from the remote control;
sending an activation signal to the electrical stun gun in order to expel the projectile; and
sending a threat notification in order to contact emergency services.

13. The method of operation of a surveillance camera for identifying and incapacitating dangerous intruders as claimed in claim 12 comprises,
analyzing the surveillance images for pixel attributes, wherein the pixel attributes include color, gradient strength, and whether an edge point or not;
extracting motion information from the surveillance images with the human body detection and tracking engine; and
recognizing human bodies by comparing the pixel attribute information and the motion information to the descriptive attribute information.

14. The method of operation of a surveillance camera for identifying and incapacitating dangerous intruders as claimed in claim 12 comprises,
receiving threat position data from the body detection and tracking engine and the laser rangefinder;
computing an azimuth angle and an inclination angle;
rotating the hinge arm about an azimuth axis to change the azimuth angle of the electrical stun gun to align with the correct projectile trajectory; and
rotating the extension arm about an inclination axis to change the inclination angle of the electrical stun gun to align with the correct projectile trajectory.

15. The method of operation of a surveillance camera for identifying and incapacitating dangerous intruders as claimed in claim 12 comprises,
identifying the threat among the human bodies by determining the specific human body in closest proximity to the threat detection sensor,
if a threat detection signal is received from the threat detection sensor.
